(19) United States
(12) Patent Application Publication
(10) Pub. No.: US 2012/0214366 A1
(43) Pub. Date: Aug. 23, 2012

(54) Mud runner out boord motor

(76) Inventor: Luke James Uhlenhopp, Waterloo, IA (US)

(21) Appl. No.: 12/924,380

(22) Filed: Feb. 23, 2011

(51) Int. Cl. B63H 20/08; B63H 20/14; F16M 13/02; B63H 20/20; B63H 20/16; B63H 19/00; B63H 23/34

(52) U.S. Cl. 440/65; 440/113; 440/75; 440/83; 440/53; 248/640

(57) ABSTRACT

A marine motor for shallow water boats that has a universal mounting bracket to fit all shallow water boats, the Mud Runner has a mid length drive system with a parallel shaft technology that has the most efficient forward thrust drive system for swallow water boats. The upper drive system is where the reverse drive system happens by way of gears and a drive shaft. The upper drive system and lower drive system are connected together by way of a drive belt. The lower drive system has an output drive shaft that comes down at an approximate 153 degree angle which then than transfers to a 0 degree angle. The 0 degree angle output drive shaft has a propeller attached to the shaft which gives this motor the forward thrust.

This is an invention that takes the combination of the surface drives performance features and the long tail's performance features and combines the best features into one mud motor design. With this design you will get the speed and forward thrust and the ability to turn a big prop that the surface drive offers with the reach of the long tail and ability to create a pocket to get to get the boat moving. Plus there are many more great features this mud motor design offers.

### DESCRIPTION AND SPECIFICATION OF INVENTION

In the two descriptions I will be explaining both of my designs that I have to offer. Each design is very unique to the function of the design; the design of these designs incorporates both of the surface drives benefits and the long tail benefits into one.

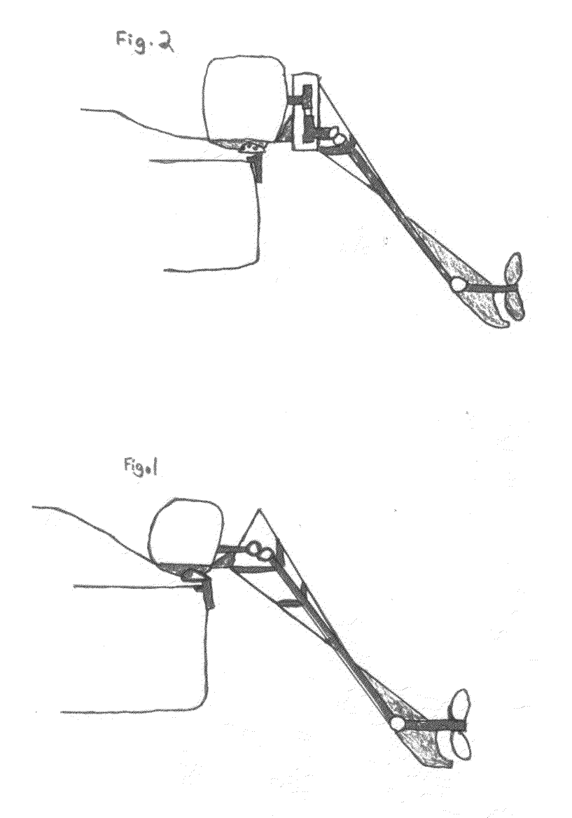

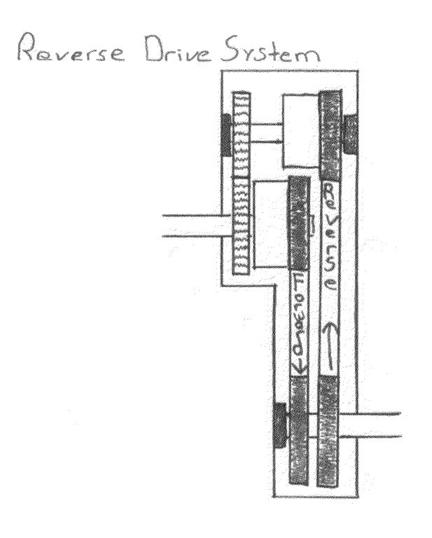

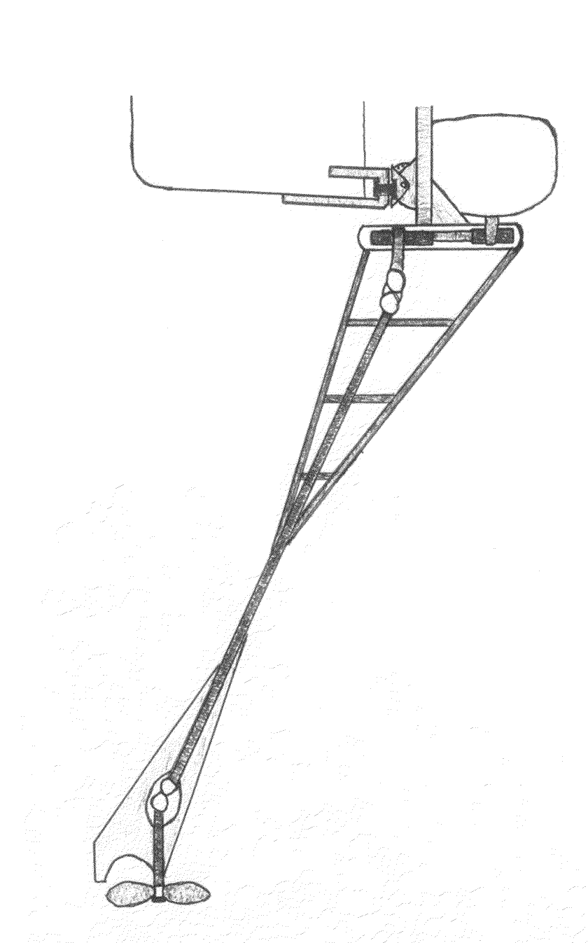

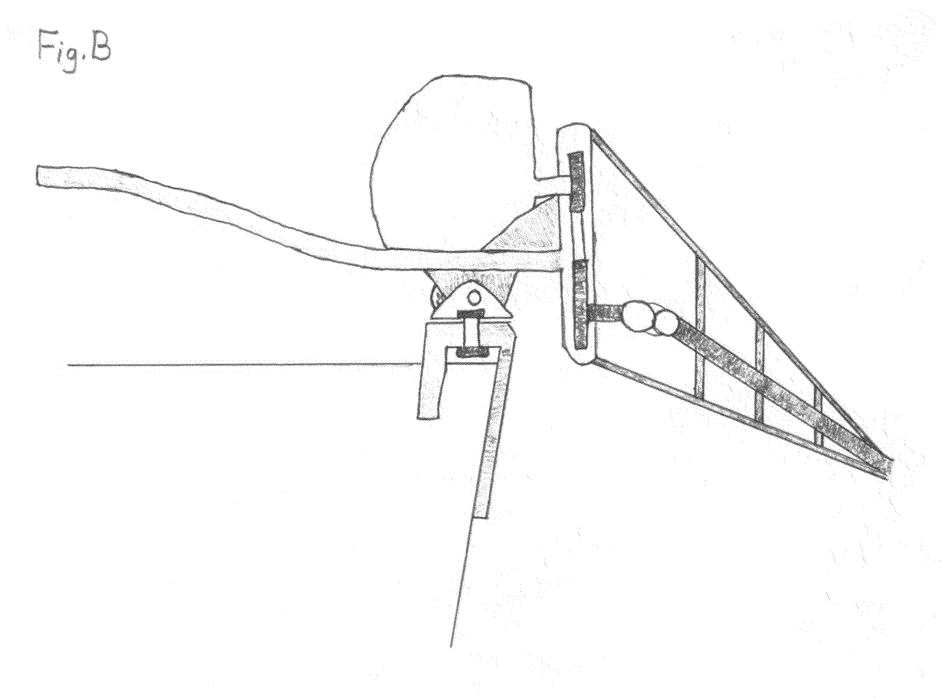

### FIG. 1 Description

In FIG. 1 I will be describing the design of how this type of design is built. I will start with the conventional mounting bracket for attaching the outboard drive assembly to the boat's hull at transom. This mounting bracket will be able to rotate 360 degrees so you will be able to secure the motor shaft in the boat while you are transporting the boat and motor to and from where you are taking the boat. The mounting bracket will have a universal bracket that connects to several different boats' transoms. Connected to first part of bracket that is mounted on the transom there will be a cylinder that is mounted to that the bracket on the transom that will stick up higher than the transom. (See drawing in FIG. 1) The cylinder then will be connected the second part of the mounting bracket. (See drawing in FIG. 1) The second part of the mounting bracket will connected to last part of the mounting bracket so that you will be able to move the bracket assembly and drive shaft assembly up and down. (See drawing of FIG. 1) The last part of the mounting bracket will be where you will be mounting of the several different number of commercially available air cooled or self-contained water cooled utility engine assemblies adaptively mounted to the last part of the mounting bracket assembly. (See drawing of FIG. 1)

In this part of the description I will describe the drive shaft framing; drive shaft assembly and the gear reducer assembly that are going to be used for this part of the build. First I will start off with the drive shaft framing bracing that is going to be used for bracing and support of the drive shaft. (See drawing of FIG. 1) The drive shaft assembly description, first you will connect the motors' horizontal drive shaft to the drive shaft with a U-joint. Then the drive shaft assembly will come down at an angle between 115 to 145 degrees. (See drawing of FIG. 1) The drive shaft will be longer than the surface drive shaft but shorter than the long tail shaft. Then the drive shaft will go in to the gear reducer housing then to the gear reducer then to the output drive shaft that will be at approximately 0 degrees. (See drawing of FIG. 1) The gear reducer will consist of miter gears with the bottom gear being bigger than the top gear to get the gear reduction. The output shaft will extend back approximately 12 to 16 inches at which a proper will be connected to. (See drawing of FIG. 1) Bracing and a bottom skeg will be added for strength and to deflect the proper from hitting objects in the water or mud that could cause damage to proper. (See drawing of FIG. 1)

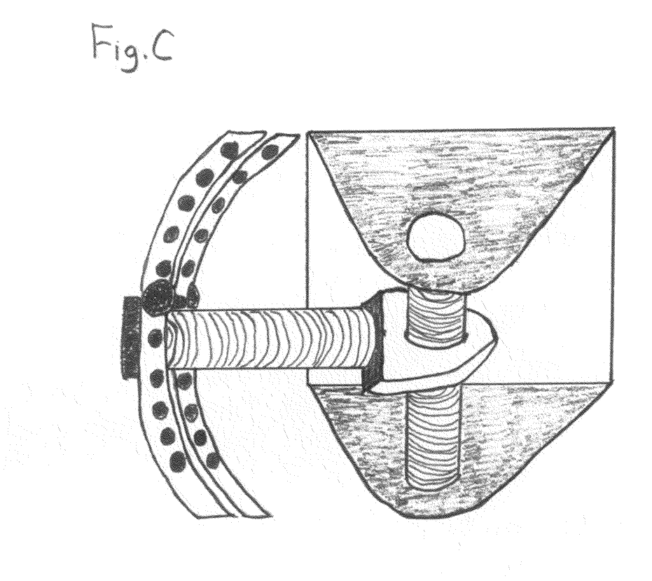

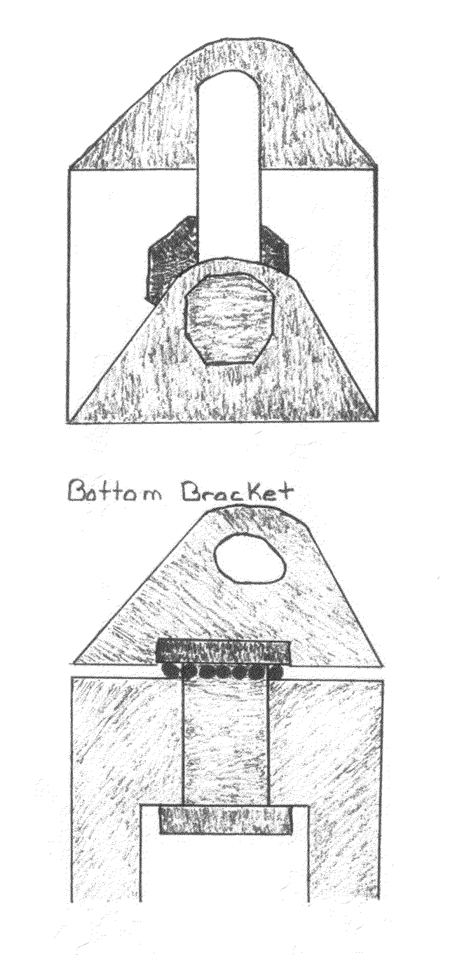

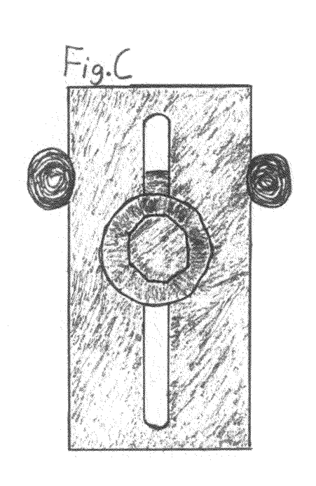

### FIG. 2 Description

In FIG. 2 I will be describing the design of how this type of design is built. I will start with the conventional mounting bracket for attaching the outboard drive assembly to the boat's hull at transom. This mounting bracket will be able to rotate 360 degrees so you will be able to secure the motor shaft in the boat while you are transporting the boat and motor to and from where you are taking the boat. The mounting bracket will have a universal bracket that connects to several different boats' transoms. Connected to first part of bracket that is mounted on the transom there will be a cylinder that is mounted to that the bracket on the transom that will stick up higher than the transom. (See drawing in FIG. 2) The cylinder then will be connected the second part of the mounting bracket. (See drawing in FIG. 2) The second part of the mounting bracket will connected to last part of the mounting bracket so that you will be able to move the bracket assembly and drive shaft assembly up and down. (See drawing of FIG. 2) The last part of the mounting bracket will be where you will be mounting of the several different number of commercially available air cooled or self-contained water cooled utility engine assemblies adaptively mounted to the last part of the mounting bracket assembly. (See drawing of FIG. 2)

In this part of the description I will describe the transmission housing along with the transmission assemblies, the drive shaft framing, drive shaft assembly and the bottom gear assembly. The transmission housing design. (See drawing of FIG. 2) The vertical transmission assembly will consist of two parts the upper drive assembly and the lower drive assembly. (See drawing of FIG. 2) He two vertical transmission drive assemblies are connected by way of a drive belt. (See drawing of FIG. 2) The upper drive assembly will consist of a timing pulley. The lower drive assembly will consist of a timing pulley which will have a larger diameter than upper drive assembly timing pulley. This is how I will get the gear reduction and the lower drive assembly pulley you will be able to interchange with other timing pulley's to fine tune the gear reduction to get optimum performance you desire to achieve. The lower drive assembly will have a horizontal output shaft. (See drawing of FIG. 2) The horizontal output shaft will be connected to the drive shaft assembly by way of a u-joint. (See drawing of FIG. 2)

Then the drive shaft assembly will come down at an angle between 115 to 145 degrees. (See drawing of FIG. 2) The drive shaft will be longer then a surface drive shaft but shorter than a long tail drive shaft. Then the drive shaft will go in to the gear housing then to the gears then to the output drive shaft that will be at approximately 0 degrees. (See drawing of FIG. 2) The gears will consist of two miter gears the same size. The output shaft will extend back approximately 12 to 16 inches at which a proper will be connected to. (See drawing of FIG. 2) Bracing and a bottom skeg will be added for strength and to deflect the proper from hitting objects in the water or mud that could cause damage to proper. (See drawing of FIG. 2) The drive shaft framing bracing that is going to be used for bracing and support of the drive shaft. (See drawing of FIG. 2)

1. An all purpose marine motor for shallow water boats.

2. The Mud Runner has a mounting bracket that has a 360 degrees rotation for steering and for placing the drive system in the boat during transportation and storing purposes.

3. The mounting bracket has a selectable trim setting of multiple different depths but still allows the motor to rotate up to drive over obstacles in the water.

4. The Mud Runner has a full power instant reverse drive system.

5. The Mud Runner has a drive system that consists of an upper and lower drive system connected by way of a belt.

6. The Mud Runner has a mid length drive shaft that comes down at an approximate angle of 153 degrees which then transfers to a 0 degree angle which then has a propeller attached to that shaft.

7. The Mud Runner has the first mid length drive shaft that has a true parallel shaft technology with the water's surface.

8. The Mud Runner has the first mid length drive shaft with parallel technology that has the most efficient forward thrust drive system.

9. The Mud Runner has a universal mounting bracket to fit all shallow water boats.

10. The Mud Runner is ran by a throttle lever and steering handle which is connected to the universal mounting bracket assembly.
